(19) United States
(12) Patent Application Publication
(10) Pub. No.: US 2002/0044103 A1
(43) Pub. Date: Apr. 18, 2002

(54) PRE-LANE DISPLAY SOFTWARE SYSTEM FOR RETAIL STORES

(76) Inventor: ROGER LEE PAULSON, ALAMO, CA (US)

Correspondence Address: TOWNSEND AND TOWNSEND AND CREW, TWO EMBARCADERO CENTER 8TH FLOOR, SAN FRANCISCO, CA, 941113834

(21) Appl. No.: 09/100,509

(22) Filed: Jun. 19, 1998

(51) Int. Cl. G09G 5/00

(52) U.S. Cl. 345/1.1

(57) ABSTRACT

A computer program product for a computer system including a processor for providing consumer information to a display system, the display system disposed adjacent to a point of sale register, the computer program product includes a computer-readable memory. The computer-readable memory includes software code that directs the processor to determine a first set of images to download to the display system, software code that directs the processor to transmit the first set of images to the display system, and software code that directs the processor to detect user input from the display system in response to the first set of images being displayed on the display system. The product also includes software code that directs the processor to determine a first set of data to transmit to the display system in response to the user input, and software code that directs the processor to transmit the first set of data to the display system.

### CROSS-REFERENCE TO RELATED APPLICATIONS

The following three commonly-owned co-pending applications, including this one, are being filed concurrently and the other two are hereby incorporated by reference in their entirety for all purposes:

1. U.S. patent application Ser. No. ______, Roger Lee Paulson, entitled, “A Pre-Lane Display System For Retail Stores,” (Attorney Docket Number 18932-000100);

2. U.S. patent application Ser. No. ______, Roger Lee Paulson, entitled, “A Pre-Lane Display Method For Retail Stores,” (Attorney Docket Number 18932-000200); and

3. U.S. patent application Ser. No. ______, Roger Lee Paulson, entitled, “A Pre-Lane Display Software System for Retail Stores,” (Attorney Docket Number 18932-000300).

### BACKGROUND OF THE INVENTION

The present invention relates generally to entertainment. More particularly, the present invention provides a technique including a method and system for entertaining customers who wait at a check-out line in a retail store. Merely by way of example, the present invention provides an improved display system in a “pre-lane” region of a grocery store, for example. But it will be recognized that the invention has a much broader range of applicability. It can be applied to variety stores, drug stores, and other places where people or customers wait in queue.

As the population of the world increases, more efficient ways for distributing food and household products have been used or proposed. Before the industrial revolution, most of the people inhabiting the Earth lived in the country sides or rural areas. A great number of these people made a living as farmers by growing agricultural based products such as fruits, vegetables, nuts, grains, and the like. Some of these people, and others, made a living by raising cattle, sheep, pigs, chicken, and other barnyard animals, which were used for meat or dairy products. Most of the products often distributed through retain outlets such as a local “general store” or a “farmer's market.” The farmer's market has been a geographical place where people gathered together, typically in an “open air” environment, to exchange food products and alike. Large numbers of people often gathered together, often during the weekends, to purchase or trade the food and household products at these outlets. Since people gathered only at limited times, these outlets could often be congested and crowded. In some cases, people even lined up in rows, similar to barn yard animals, and patiently waited to purchase certain highly prized goods and the like. Waiting in lines was time consuming and boring even in the early days.

As worldwide industry shifted from agricultural based to industrial based, people migrated to cities for work. In the cities, people lived in more densely populated areas and often purchased food, household goods, and clothing at small stores and outdoor market centers. The small stores often carried goods and household products and sold them to people who lived near the store. Large open market centers having numerous merchants also sold people varieties of food and other products. During busy times, many people had to wait in line in order to pay a merchant money to purchase goods at the small store or market center. Since the cities were generally more densely populated than the country, the waiting time and line length to purchase a good often increased with population growth. As the population of the city grew larger, the lines and waiting times also increased proportionately. Waiting in lines was still time consuming and thought to be a waste of time.

Many of the traditional market centers and small stores have been replaced, in part, by extremely large or “mega” retail outlets. These outlets carry numerous varieties of food, clothing, household goods, and the like. People, now commonly known as “shoppers” or the customers, purchase goods from many large retail stores such as Safeway™, KMART™, Target™, and others. Purchasing goods often requires processes of: (1) selecting the goods; and then (2) paying for the goods. Most shoppers often feel that the selection process in most retail stores is often an easy and pleasant experience. Large automatic doors often allow the shopper to enter the store. Relaxing background music is played in the store to provide for a soothing shopping experience. Rows of carts and stacks of baskets are often placed near the store entrance at a convenient location for the shopper. Large shelves facing aisles hold and display many types of goods, including canned goods, paper packaged goods, packaging material, fruits, vegetables, nuts, meats, poultry paper towels, toilet paper, soap and other cleaning products, magazines, toys, sporting goods, beer, champaign and even caviar, and the like. The aisles are often wide for ease in access. Large signs and labels on the aisles and shelves identify the goods being displayed. Central heating and cooling regulate the climate in the store. Unfortunately, long lines generally await at the check-out counter. In fact, most conventional retail outlets have a limited number of clerks or check-out lines or lanes, which often lead to long waiting periods and lines of shoppers before each check-out clerk. As these outlets become larger, which seems to be the trend, the costs of maintaining them also increase. In most cases, fewer people or clerks have been hired to control costs. Accordingly, larger stores have even longer lines and longer waiting periods, which lead to greater congestion at the check-out lanes.

Automation has, in part, solved some of the waiting at store check-out lanes. Automation includes the use of scanners or bar code readers, automated point of sale debit and credit card devices, and other electronic devices. Although automation has solved some of the congestion in check out lanes, greater numbers of shoppers in these larger outlets cause even further increased lines and waiting periods. Accordingly, it is clear that waiting in lines is merely a part of the shopping experience in conventional modern day living. As long as people inhabit the earth and buy goods in retail stores, they shall wait in lines.

From the above, it is seen that a technique for enhancing wait time in long lines in retail outlets is highly desired.

### SUMMARY OF THE INVENTION

According to the present invention, a technique is provided to improve entertainment in a retail outlet or the like. In an exemplary embodiment, the present invention provides an improved display method for entertaining customers in, for example, a pre-lane region of a grocery store.

In a specific embodiment, the present invention provides an entertainment software system for use in a retail store or the like. The computer program product for a computer system includes a processor for providing consumer information to a display system. The display system is typically disposed adjacent to a point of sale register. The computer program product includes a computer-readable memory. The computer-readable memory includes software code that directs the processor to determine a first set of images to download to the display system, software code that directs the processor to transmit the first set of images to the display system, and software code that directs the processor to detect user input from the display system in response to the first set of images being displayed on the display system. The product also includes software code that directs the processor to determine a first set of data to transmit to the display system in response to the user input, and software code that directs the processor to transmit the first set of data to the display system.

In an alternative embodiment, the present invention provides a computer program product for a computer system including a processor for providing consumer information to a display system. The display system is typically disposed prior to a cash register. The computer program product includes computer code that directs the processor to determine a first set of images to download to the display system, the first set of images comprising a second set of images and computer code that directs the processor to transmit the first set of images to the display system. Computer code that directs the processor to detect user input from the display system in response to the second set of images being displayed on the display system is also disclosed. The computer program also includes computer code that directs the processor to determine a third set of images to download to the display system in response to the user input, and computer code that directs the processor to transmit the third set of images to the display system.

Numerous advantages are achieved by way of the present invention. In some embodiments, the present invention allows shoppers to be entertained while standing in line to be checked out in a supermarket or the like. Additionally, the present invention provides a medium for a variety of video/audio output such as moving pictures, graphic pictures, still pictures, text, and other forms of visual output in some embodiments. In other aspects, the present invention provides a technique for advertisers or entertainers to be coupled directly to a potential customer by way of “pin point” advertising, unlike conventional “bill boards” and the like. In yet other aspects, the present invention can be applied using, in part, conventional technology that is easy and cost effective. In still further aspects, the present invention provides pin point advertisement and/or entertainment using selected information about the target audience or customers, which is more efficient than conventional techniques. Depending upon the embodiment or embodiments, the present invention can achieve one or more of the aforementioned advantages, as well as others. These advantages will be described in more detail throughout the present specification and more particularly below.

These and other embodiments of the present invention, as well as its advantages and features, are described in more detail in conjunction with the text below and attached Figs.

### BRIEF DESCRIPTION OF THE DRAWINGS

FIG. 1 is a simplified diagram of a conventional lane in a retail store;

FIG. 2 is a simplified diagram of a general overview of a networked system according to an embodiment of the present invention;

FIG. 3 is a simplified diagram of a display system according to an embodiment of the present invention;

FIG. 4 is a simplified block diagram of display hardware according to an embodiment of the present invention;

FIGS. 5-8 are simplified diagrams of displays according to embodiments of the present invention;

FIGS. 9-12 are simplified diagrams of a method according to an embodiment of the present invention;

FIG. 13 is a more detailed block diagram of a image server 1120 according to a preferred embodiment of the present invention; and

FIG. 14 illustrates a block diagram of a flow diagram according to an embodiment of the present invention.

### DESCRIPTION OF SPECIFIC EMBODIMENTS

### CONVENTIONAL SUPERMARKET LANE

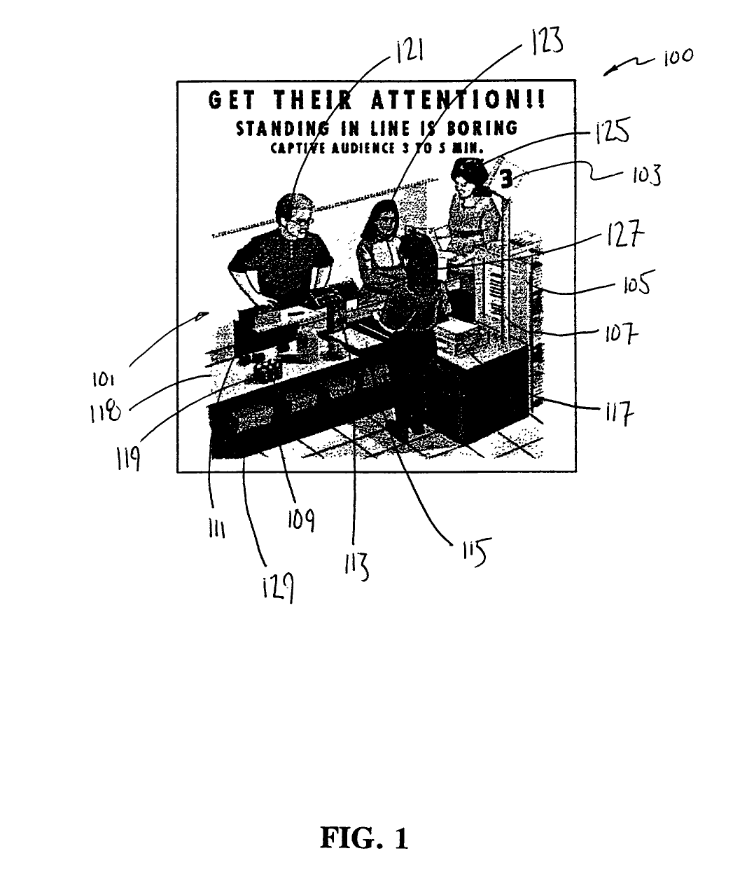

FIG. 1 is a simplified diagram 100 of a conventional lane in a retail store such as a grocery store, for example. Lane 100 includes a variety of features such as an in-lane runway 101 that allows one of a plurality of customers 121, 123, and 125 to stand in a line and wait on one side of a lane counter 118 for a check-out clerk 127. The checkout clerk generally stands on the other side of lane counter 118 to serve one of the customers 121. Some conventional lanes use multiple check-out clerks. The lane can generally be divided into a plurality of regions such as a point of sale region, which is commonly called the POS, which is the location where the transaction occurs. In particular, customer 121 stands at the POS while clerk 127 receives the goods to be purchased from the customer, tallies the cost of the goods, and checks out customer 121. The goods are also “bagged” and can be placed in a shopping cart at a post-lane region (not shown). As shown, the lane also includes a pre-lane region for customers 123 and 125 that stand and wait for customer 121 to finish his transaction. Standing in line and waiting is often boring and takes from minutes to a good part of an hour in some cases.

The conventional lane counter 118 generally has a variety of hardware features such as a lower counter surface that supports a plurality of items 119, which can be groceries or the like. Lane counter 118 also has an upper counter surface 109 with a customer input device 109 and clerk input device 113. The customer input device is often used for paying for the groceries, for example. The input device can often use plastic debit and/or credit cards such as ATM cards, credit cards, store cards, and the like. Clerk input device 113 often has alpha numeric keys for entering numerical and alpha-type characters. The input device also has other special key features depending upon the application.

The counter also has a variety of other hardware features. These features include a storage location 129 underlying the counter surface. Additionally, the counter may have a scale 115 or the like. The counter often has a scanner for scanning bar codes and the like. A register 117, which is commonly termed a “cash register,” is also a part of the counter. The cash register is often coupled to the user input device, clerk input device, scale, scanner, and other elements on the counter. The cash register can also have a printer for outputting a receipt, and the like.

The counter also has a counter number 103 and counter rack 105. The counter number designates the number of the counter, which are often in rows that are parallel to each other. The counter number is often lighted when operational and sits atop a pedestal 107. The counter rack 105 is often placed in the pre-lane region. The counter rack often supports and displays “high margin” impulse items such as magazines, snacks (e.g., candy, gum, breath mints), and canned or bottled goods. Store owners often place such high margin items in the pre-lane region since all customers must walk by them and, perhaps, purchase one or more of the items that are decoratively placed in the counter rack.

The conventional lane in a retail store has numerous limitations. As merely an example, customers are captive in the lane and often need to wait in line, which is often boring and time consuming. Additionally, customers who have children often have the task of keeping their children from “raiding” the counter rack of candy, magazines, and the like. Furthermore, store owners simply have limited options on how to make the shopping experience more enjoyable for customers or shoppers at the checkout counter, which is often crowded at peak times. As profit margins further decrease in the grocery or retail store businesses, store owners will be further challenged to maintain the number of clerks without aggravating to the length of time spent by customers at the check-out counter. Alternatively, store owners may be forced to reduce the workforce in a typical store without influencing the quality of the shopping experience. That is, store owners will be forced to make the check-out counter more efficient at the expense of fewer store clerks and the like in most cases. These and other limitations are described throughout the present specification and more particularly below.

### PRESENT SUPERMARKET LANE

### I. SYSTEM HARDWARE

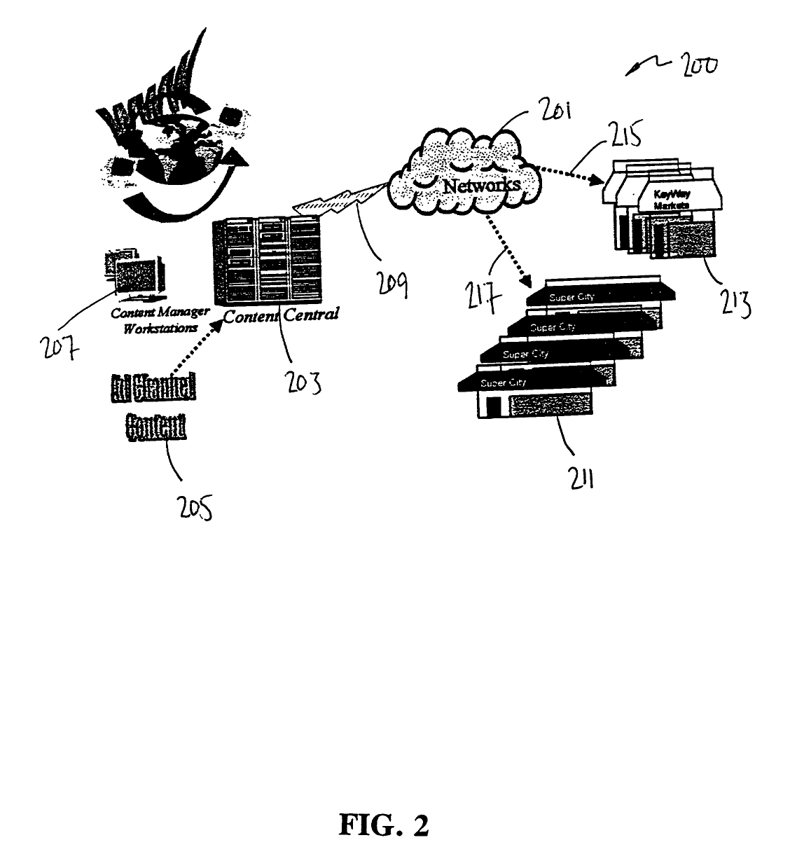

FIG. 2 is general overview of a networked system 200 according to an embodiment of the present invention. This diagram is merely an illustration and should not limit the scope of the claims herein. One of ordinary skill in the art would recognize other variations, modifications, and alternatives. Among other elements, the present system 200 includes a plurality of stores 211 or 213, which correspond to a first chain store 211 and a second chain store 213. The store can be a discount store, a grocery store (e.g., Safeway™), a hardware store (e.g., Home Depot™), a variety store such as KMART™ or the like. Alternatively, the store can be a leased department within a larger store. The stores each communicate to each other and to a central location 203 by way of a network 201. The network can be any suitable wide area network or the like. The network can be based, in part, on a variety of formats such as SNA, TCP/IP, cable, satellite, and the like. The network connection can be based upon telephone lines, optical lines, cable lines, or wireless systems such as satellite, cableless, totem pole, and others. The network also includes a variety of other elements such as switches, routers, bridges, bandwidth management products, firewalls, and the like.

The network 201 couples to the central location 203, which stores and distributes content to one or more of the stores. The central location distributes information (e.g., data, video, audio) to be transmitted to one of a plurality of stores. Alternatively, the central location receives information from one or more of the stores. The central location often includes a server 203, which has memory devices and the like, which can be a hard disk, a plurality of disks, floppy disk drives, semiconductor memories, tapes, and other storage devices. The server can be microprocessor based such as an Intel Pentium™ microprocessor made by Intel Corporation of Santa Clara, Calif., or other processing means. The server can also be a Web server or the like. The server can be based upon a platform such as a UNIX operating system, a Windows NT™ operating system by Microsoft Corporation of Redmond, Wash., and others. The server includes channel content 205, which can be controlled by a content manager, i.e., workstation(s) 207. One or more of the stores receives information from the central location. This information can be displayed by way of a novel display system according to the present invention. More details with regard to the display system are discussed below.

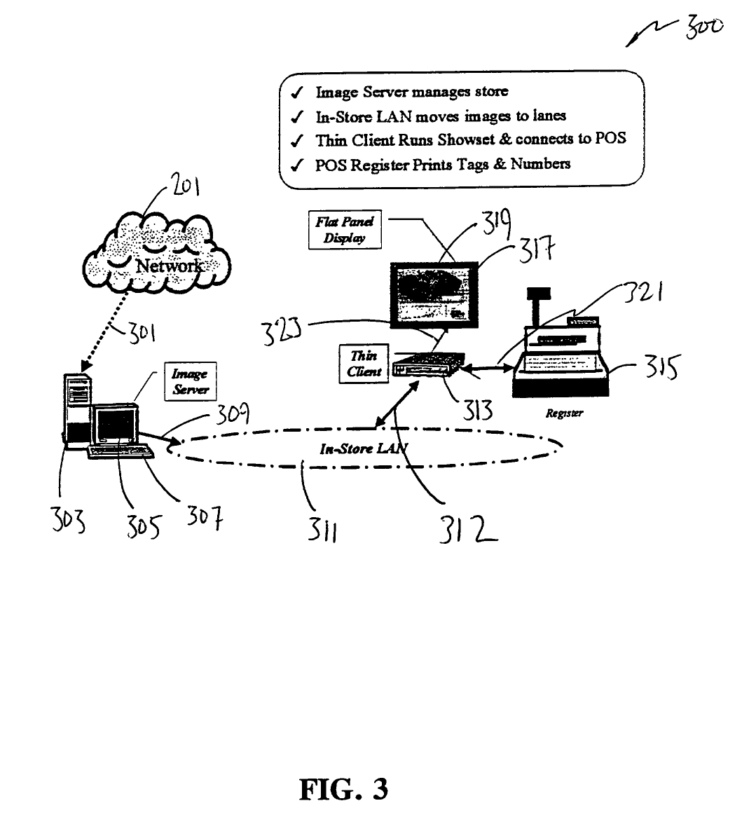

FIG. 3 is a simplified diagram of a display system 300 according to an embodiment of the present invention. This diagram is merely an illustration and should not limit the scope of the claims herein. One of ordinary skill in the art would recognize other variations, modifications, and alternatives. Like reference numerals are used in FIG. 3 as one or more of the previous Figs. for easier cross-referencing. The display system 300 receives and transmits information from the network 201. The information often transfers from the network to an in store local server 303 by way of connection 301. The local server often includes a variety of hardware elements such as a keyboard input device 307 coupled to the server, and a display device 309, which is coupled to the server. The server is also often coupled to a local area network 311, which is commonly called a LAN.

The local server oversees the functions of the local store. The local server is often a personal computer or the like. The personal computer can include a PC based unit. As merely an example, the personal computer uses a microprocessor based integrated circuit chip such as an Intel Pentium™ microprocessor or other processing means. The server can include a variety of programs for use in the local area network. The server can also include a firewall, which prevents a possibility of any unauthorized use of the local area network. Additionally, the server can include a bandwidth management product for controlling the information coming into and out of the local area network. The server is also coupled to a large memory storage device such as a plurality of hard drives, floppy drives, integrated circuit memory chips, optical disks, tape drives, and others. The memory device is used to store programs as well as information files for the local area network.

The local area network uses one or more of many common platforms and the like. As merely an example, the local area network can be based, in part, upon Ethernet, Token Ring, TCP/IP, and others. The local area network can be implemented using products called Microsoft™ NT™, Novell™ NetWare™, and Intranets or other Web products. The local area network can also be “wireless” such as a Ricochet™ wireless product made by Metricom Corporation of Los Gatos, Calif. The local area network also can be based upon cable television technology and others. The local area network controls the information such as images to one or more of the displays in the lanes. Of course, the type of network used depends upon the application.

The local area network couples to a client 313, which can be a “thin” client or the like, through line 312. The client interfaces between a cash register 315 through line 321 and novel display apparatus 317 through line 323. The client can be hardware and/or software based. The client can be in a set top box or the like. The client selectively controls the flow of information to and from the local server to and from the display. The client also selectively controls the flow of information to and from the register to the display or local server in some embodiments.

The register is commonly called the “cash register” as noted. The register can be any suitable input/output device that allows the store clerk to make transactions. As merely an example, the register is a product called 4698 made by IBM. Alternatively, the register is a product called 2127 made by NCR. The register starts transactions, manages cash, stops transactions, and enters other information into the local server. The register is also coupled to an output device such as a printer, change machine, and the like. Of course, the exact features used by the register depend upon the application.

The present display 317 outputs visual information 319. The visual information can include still images, graphics video, text, combinations thereof, and the like. The display can be any suitable unit capable of outputting analog and/or digital information. The display can be a CRT, flat panel display, active matrix liquid crystal display, passive liquid crystal display, and the like. As merely an example, the display is a flat panel product made by a company called Zendex of Dublin, Calif. In some embodiments, the display also can be coupled to an audio device such as speakers or the like. Accordingly, the combination of the display and the audio device provide images and sound in some embodiments.

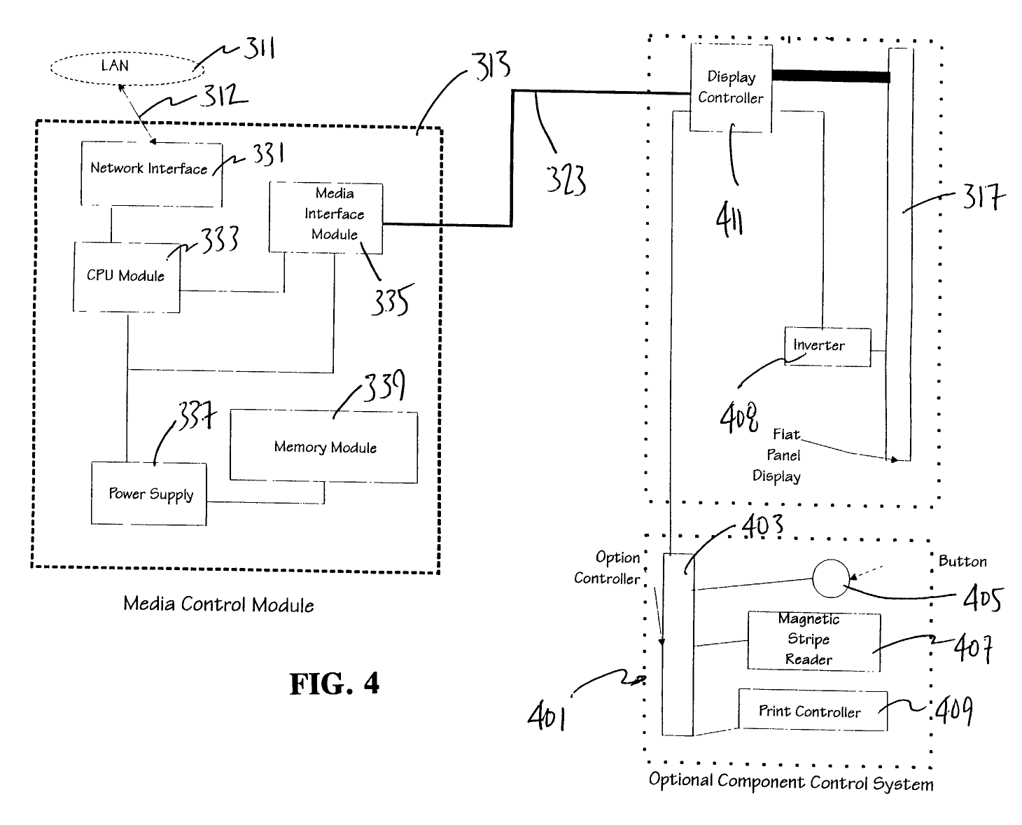

The present display is coupled to client 313, which is called the thin client. The client 313 connects to the local area network 311 in some embodiments. Alternatively, the client 313 can connect to a wide area network. The client also can be extremely thin, which makes the display similar to a “dumb” terminal or the like. The client includes a variety of hardware and/or software features. The client can be placed in memory of a storage unit. Alternatively, the client can be in a “box” or on a card, for example. Details of these features in the client are shown by reference to FIG. 4, for example.

FIG. 4 is a simplified block diagram of display hardware according to an embodiment of the present invention. This diagram is merely an illustration and should not limit the scope of the claims herein. One of ordinary skill in the art would recognize other variations, modifications, and alternatives. Some of the reference numerals used herein are similar to ones used throughout the specification for easier cross-referencing. The display hardware includes a variety of elements such as the client 313 that is connected to the local area network 311 using connection 312. The client 313 is connected to display 317 by way of connection 323.

The client includes various features. These features, among others, are network interface 331, which can be in the form of hardware (i.e., card) or software. The client also includes a central processing unit (“CPU”) module 333 that is coupled to the network interface. The CPU also couples to power supply 337, memory module 339, and media interface module 335. The power supply can be any suitable unit for providing power to the display and client, for example. As merely an example, the power supply is any suitable product having sufficient voltage and noise characteristics. The CPU module is a hardware and/or software combination, but is not limited. Media interface module is a custom program or hardware that provides input/output controls to and from the display 317.

The client couples to display via connection 323. The display includes a variety of features such as a display controller or driver 411. The display controller provides information to the display and also provides information to inverter 408, which is also coupled to the display. The display generally provides visual information, which can include still images, graphics video, full motion video, combinations thereof, and the like. The display can be any suitable unit capable of outputting analog and/or digital information. The display can be a CRT, flat panel display, active matrix liquid crystal display, passive liquid crystal display, and the like. As merely an example, the display is a flat panel product made by a company called Zendex of Dublin, Calif. In some embodiments, the display also can be coupled to an audio device such as speakers or the like. Accordingly, the combination of the display and the audio device provide images and sound in some embodiments.

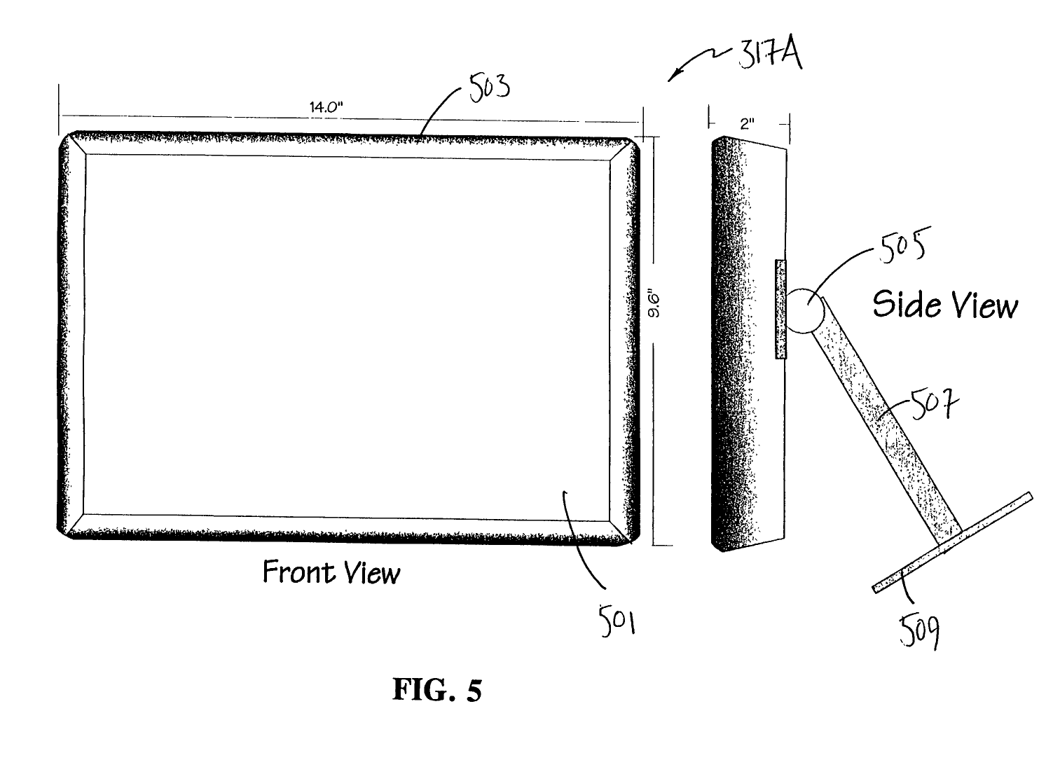

As merely an example, the display 317 (now 317A) is shown by way of the simplified diagram of FIG. 5. This diagram is merely an illustration and should not limit the scope of the claims herein. One of ordinary skill in the art would recognize other variations, modifications, and alternatives. Some of the reference numerals used herein are similar to ones used throughout the specification for easier cross-referencing. Among other elements, display 317 includes a screen 501, which outputs visual information, and an outer support or periphery 503. The display is often durable and can withstand a variety of environments and hostile conditions such as mechanical pressures or infliction by mechanical objects, chemicals, and other hazards in a retail store, for example. The display is mounted using a bracket that is pivotable 505 to adjust the pitch of the display. The bracket also includes a bracket arm 507, which is coupled to or connected to a flat mounting surface 509, but is not limited. The mounting surface is easily attached to, for example, a lane rack or the like.

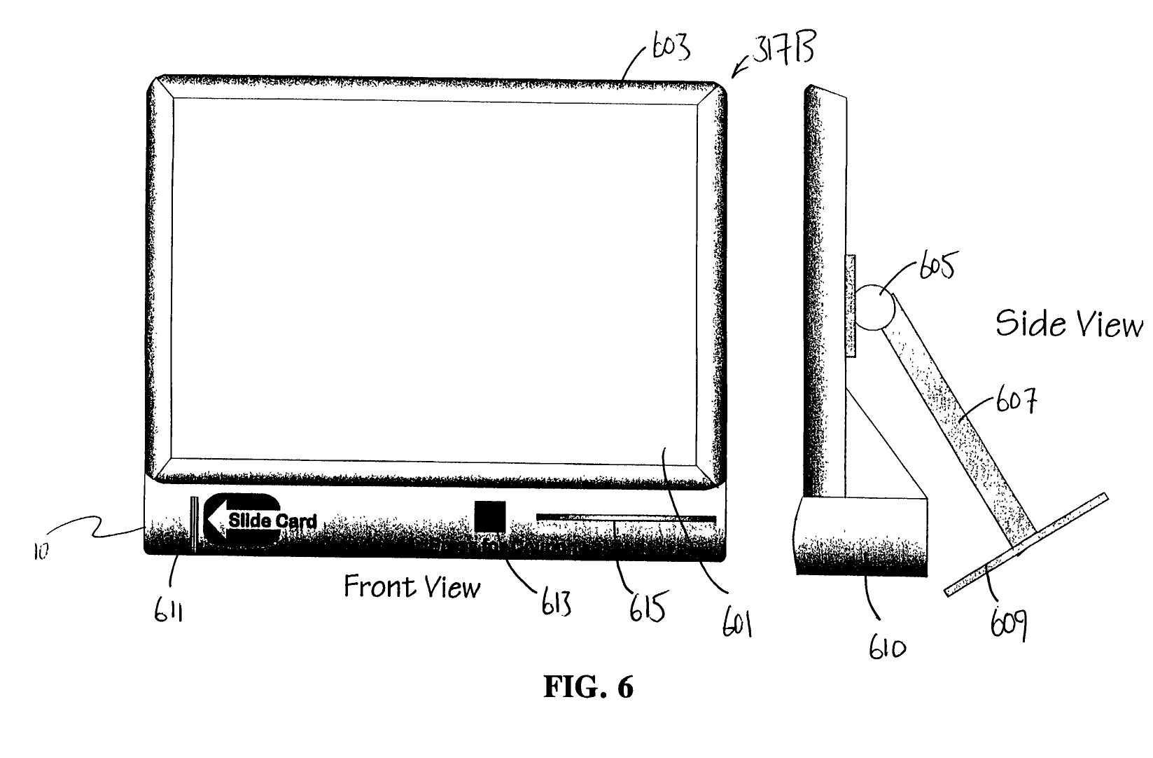

Referring to FIGS. 4 and 6, the display 317B also has an optional control system 401 for providing input and/or output information from and to a customer or user. The control system 401 is provided for a user input device and/or an output device, which coupled to controller 403. In particular, the control system 401 includes a magnetic stripe reader 407, which receives information with a store card or the like. Alternatively, the reader can be almost any reader for receiving and even writing information into, for example, a smart card, stored value card, an optical card, smart money, and other forms of information storage devices. The store card can include information such as a user name, user identification number, user address, user e-mail location, bonus points, items purchased, and other information. The strip reader couples to controller 403, which couples to the client 313 and display 317.

The control system 401 also includes a user input device such as button 405, which can be pressed by a user to provide a signal to begin outputting information to, for example, a printer or the like. The button couples to the controller. The control system also includes a print controller, which can receive a signal from the controller 403. The print controller selectively provides output to the printer. The printer can output hard copies of advertisements, promotions and the like. As merely an example, the display 317 having optional control system 401 is shown by way of the simplified diagram of FIG. 6. This diagram is merely an illustration and should not limit the scope of the claims herein. One of ordinary skill in the art would recognize other variations, modifications, and alternatives. Some of the reference numerals used herein are similar to ones used throughout the specification for easier cross-referencing only. Among other elements, display 317 includes a screen 601, which outputs visual information, and an outer support or periphery 603. The display is often durable and can withstand a variety of environments and hostile conditions such flying mechanical objects, chemicals, and other hazards (e.g., children) in a retail store, for example. The display is mounted using a bracket that is pivotable 605 to adjust the pitch of the display. The bracket also includes a bracket arm 607, which is coupled to or connected to a flat mounting surface 609, but is not limited. The mounting surface is easily attached to, for example, a lane rack or the like in the pre-lane region. The display also is mounted to be observed by customers in the pre-lane region.

As shown, the display 317 (now 317B) also has a lower region 610 for a variety of input and output devices, as previously noted. The lower region is connected to the bottom of the display 317B. The lower region includes a strip reader 611, which can read and/or write to a store card, for example. Alternatively, the reader can be almost any reader for receiving and even writing information into, for example, a smart card, an optical card, smart money, and other forms of information storage devices. The lower region also includes an input device such as a button, which can be pressed or actuated to provides a signal to the controller 403. In a specific embodiment, the button provides a signal, when pressed, to output hardcopy information at a printer location, which is output from slot 615. The features on the lower region can also be coupled to other locations (e.g., edge, top) of the display. The features on the lower region can also be detached from the display. These features also are merely examples and should not limit the scope of the claims herein.

Although the above has generally been described in terms a combination of software and hardware, other variations can also exist. As merely an example, the functionality of the elements above can be further combined, or further separated. Additional features can also be added or inserted into any one of the above software and/or hardware elements. As merely an example, the hardware elements in the client can be provided in, for example, the server or even be distributed in terms of software or the like. Accordingly, the present specification is not intended to limit the scope of the claims herein.

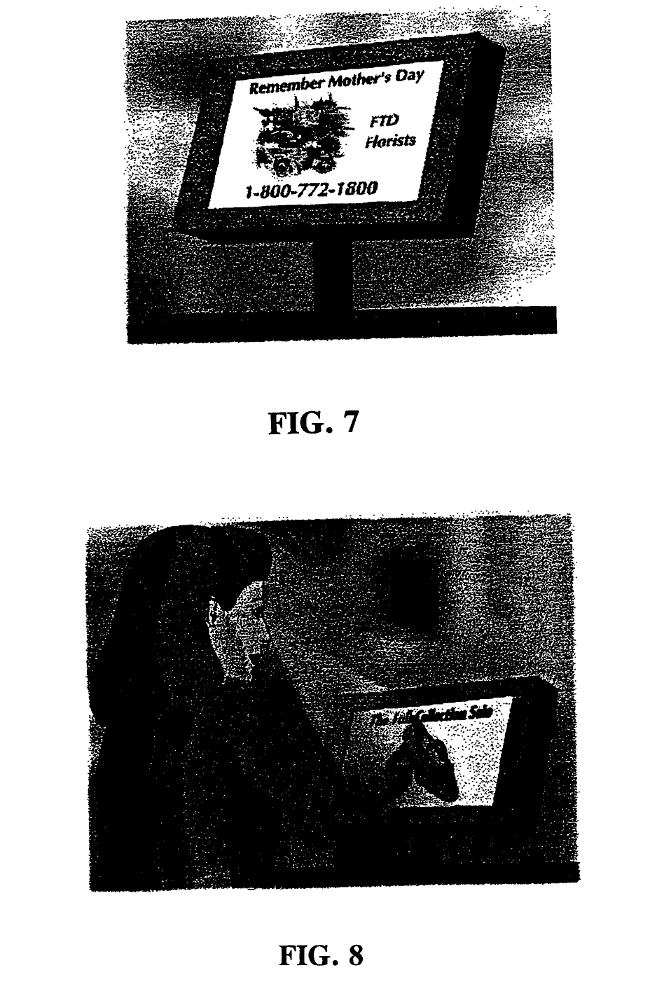

FIGS. 7-8 are simplified diagrams of displays according to embodiments of the present invention. These diagrams are merely illustrations and should not limit the scope of the claims herein. One of ordinary skill in the art would recognize other variations, modifications, and alternatives. In one aspect of the invention, the present invention provides a display for advertising, which has been provided by way of, for example, the Internet. The display can have an advertising that is based, in part, upon the particular day such as an FTD Florists advertisement in FIG. 7. As shown, the display outputs a “Remember Mother's Day” prompt in text. Flowers are displayed in graphical form and a phone number is also displayed. In another aspect, a “Fall Collection Sale” from a major department store is advertised, as shown in FIG. 8. As shown, the display outputs a “The Fall Collection Sale” prompt. Shoes are shown in graphical form. A shopper views the image, while waiting in line at the check-out counter. In addition to these displays, many other display outputs can also exist.

Although the above has generally been described in terms a combination of software and hardware, other variations can also exist. As merely an example, the functionality of the elements above can be further combined, or further separated. Additional features can also be added or inserted into any one of the above software and/or hardware elements. As merely an example, only a single display has been shown, but multiple displays can be used. Accordingly, the present specification is not intended to limit the scope of the claims herein.

### II. SYSTEM SOFTWARE

A method according to the present invention can be briefly outlined as follows:

(1) Provide information about customers using the store;

(2) Provide information about time period for using the present method in the store;

(3) Enter the customer information and time period information;

(4) Select show set or sets from memory based upon customer and time information;

(5) Queue show set or sets to be displayed;

(6) Transmit show set or sets to one of a plurality of displays;

(7) Display show set or sets to be observed by customers; and

(8) Perform remaining steps, as desired.

The above sequence of steps provides a technique for using customer and time information to select advertisements and/or entertainment to be displayed on a pre-lane display media. Since specific geographic customer information and/or time information are used, the present method provides pin point advertising and/or entertainment to customers who wait in line in, for example, a grocery store. The present method is therefore more effective than conventional techniques, e.g., bill boards, and the like. Details with regard to the present method are described by way of the Figs. below.

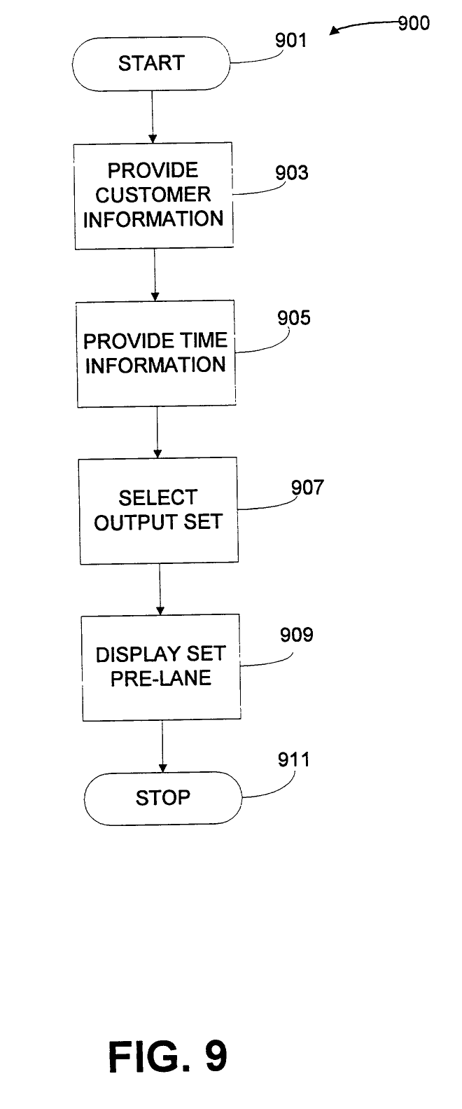

FIG. 9 is a simplified flow diagram 900 of method according to an embodiment of the present invention. This flow diagram is merely and illustration and should not limit the scope of the claims herein. One of ordinary skill in the art would recognize other variations, modifications, and alternatives. The flow diagram begins with start, which is step 901, but is not limited. That is, the start step is derived from another step or as an initiation step. The method provides customer information (step 903) to be evaluated. Customer information includes targeted customer and/or audience characteristics such as, for example, upscale, young family, ethnic, and other specific characteristics based, in part, upon specific store demographics. The method also provides time information, which includes, among others, time of year (e.g., month), day of week, and time of day, which includes morning, noon, afternoon, evenings, and nights. Special seasonal characteristics are also included. For example, seasonal characteristics are based, in part, upon holidays (e.g., Easter, Christmas, Thanksgiving), and other factors.

Based upon the information provided in some embodiments, an output or set of outputs are selected, step 907. The selection of the output can also be based upon other information or portions of the information described herein. The output is generally stored in a memory (e.g., database, floppy disk, optical disk, memory chips, removable hard drives, fixed hard drives). Depending upon the application, the output can vary.

In a specific embodiment, the output includes multiple images, which has an image segment for advertising and an image segment for entertainment. Some of these images, if not all, can be displayed for a few seconds, up to ten seconds and longer, or a minute and longer. In some embodiments, these images are solely for entertainment purposes, e.g., entertainment images. In other embodiments, the images are solely for advertisements. In still further embodiments, the images are a combination of entertainment images and advertising images. In preferred embodiments, about one-third or less of the images are for advertisements and the remaining images are for entertainment. Alternatively, one-third or more of the images are for advertisements and the remaining images are for entertainment. The combination of these images can run or be displayed for about one minute or longer, or at least two minutes.

In a specific embodiment, the entertainment images can be derived from a data source. The data source can include, among others, the Internet, television network, and fixed memory sources. The entertainment images can be uploaded onto the local server or can be sent directly to the client, which is coupled to the display in other embodiments. Of course, the particular source of the entertainment images depends upon the application.

The entertainment segment includes video images. These images are full-color and can have animation, which has strong shopper appeal. The images can display fashion, celebrity personalities, flowers, travel photos, cartoons, and other forms of entertainment. In embodiments using an Internet connection, a wide variety of image choices can be used. These choices include topics such as news, weather, traffic, and sports information, which can be updated based upon information such as time and shopper type. The video images can be combined with audio. Alternatively, the images can be still. They also can be still and combined with audio. The images can also be a combination of video, still images, and audio in other embodiments.

In a specific embodiment, the advertisement images can be derived from a data source. The data source can include, among others, the Internet, television network, and fixed memory sources. The advertising images can be uploaded onto the local server directly from the advertiser or can be sent directly to the client from the advertiser. The data source can also be from the local server in the store, for example. Of course, the particular source of the advertising images depends upon the application.

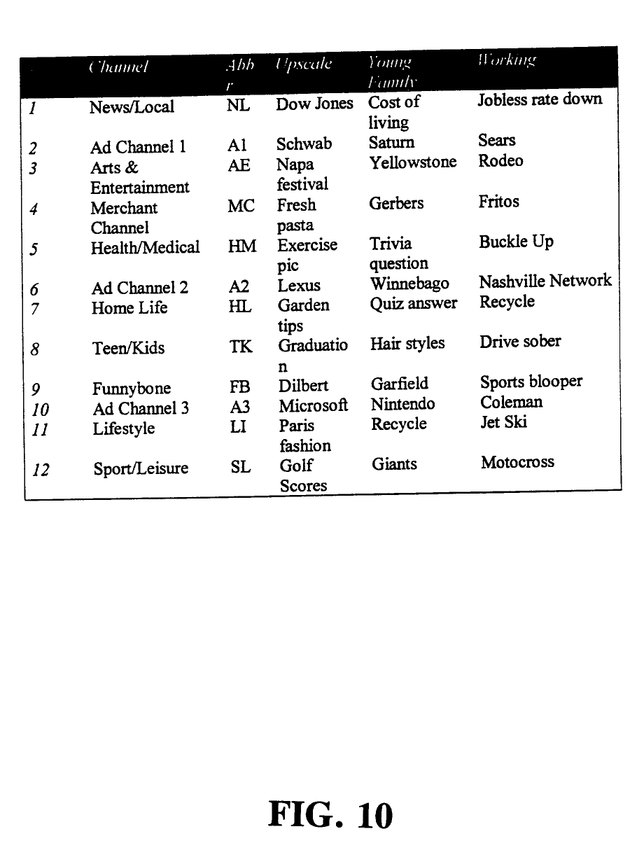

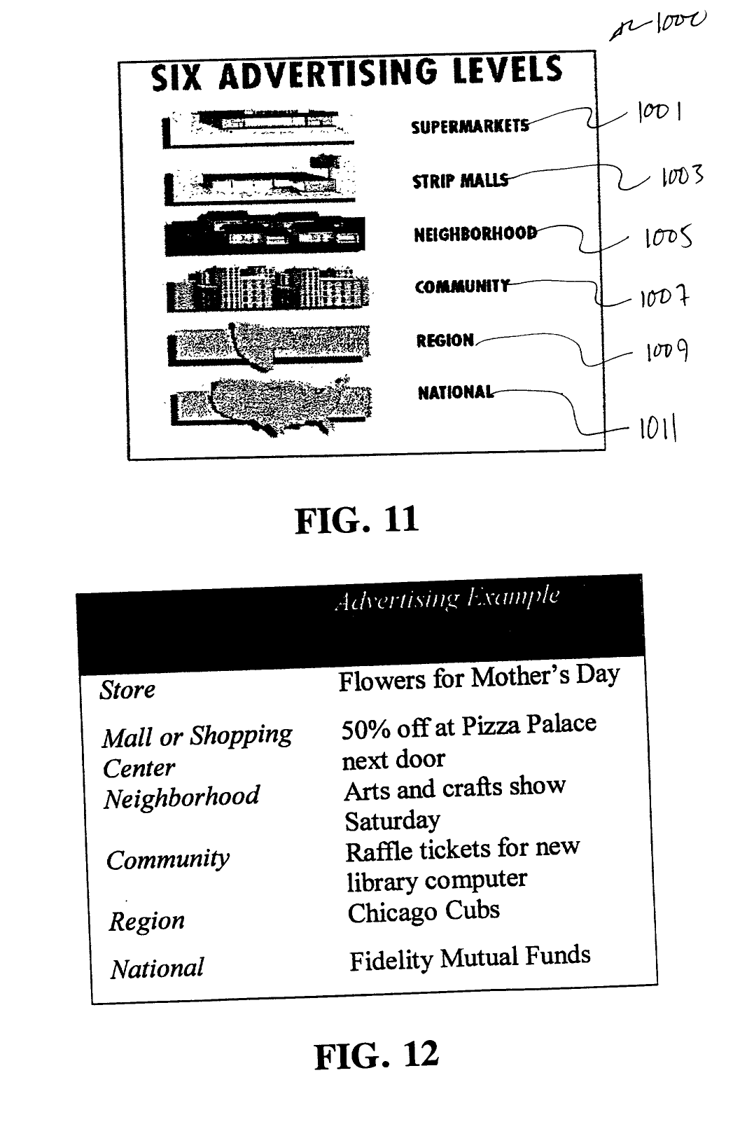

As merely an example, FIG. 10 shows a simplified sample set of images that can be displayed. In a specific embodiment, the set of images can be placed on multiple channels, e.g., channel 1 to 12, as shown. The channels can include topics such as News/Local, Ad Channel 1, Arts & Entertainment, etc. A symbol is used to identify the specific channel. As shown, the symbol for News/Local is “NL,” for example. As shown, the set includes channels (e.g., 1, 3, 5, 7, 8, 9, 11, and 12) for entertainment and channels (e.g., 2, 4, 6, and 10) for advertisements. Accordingly, sports, weather, arts, cartoons, and the like can be displayed in combination with advertisements for food, cars, and computer equipment.

The sample images also form three sets for different customer audiences. As merely an example, the sets include a set of images for an “upscale” audience, which may be people from an expensive housing area such as Beverley Hills, Alamo, or Palo Alto, Calif., for example. An additional set may provide images to a young family audience. This set has images of the San Francisco Giants™, Recycling News, and Present Hair Styles, and the like. Furthermore, a specific set may be used for a “blue collar or working” audience. The blue collar audience set can include images or advertisements for Jet Skis, Motocross, and Fritos brand potato chips. Of course, the particular set used depends highly upon the audience to provide pin-point entertainment and/or advertising.

The method transfers the images from the local server and displays one or more of the images from a selected set or sets, as provided by step 909. The display is often located to entertain customers who wait in line before the POS. In a specific embodiment, the display can be attached to a lane rack. The display is pointed or directed toward customers who wait in line. The particular viewing angle of the display and number of displays will depend upon the application. The sequence of steps can be stopped (step 911) or repeated depending upon the application, as well as the targeted audience, time of day, and other factors.

In a specific embodiment, the present method can provide multiple levels of entertainment or advertising, as illustrated by way of simplified diagrams 11 and 12. These diagrams are merely illustrations and should not limit the scope of the claims herein. One of ordinary skill in the art would recognize other variations, modifications, and alternatives. In a specific embodiment, the present invention provides for multiple levels 1000 of advertising such as products from a single or chain store 1001. In another embodiment, the present invention provides advertising from a shopping center 1003. In an additional embodiment, the present invention provides advertising for a specific neighborhood 1005. Alternatively, advertising can come from a community 1007, geographic region 1009, nationally 1011, or world-wide in other embodiments. The advertising from a specific region can be provided by itself, or be combined with other regions depending upon the application.

As merely an example, FIG. 12 shows an example of some advertising images. Store advertising can include flowers for Mother's Day. Mall or shopping center advertising can by food advertising and images. An arts and crafts show advertisement in the form of images can be neighborhood advertising. Community advertisements can include the sale of raffle tickets. Regional advertising can be a Chicago Cubs image. Furthermore, national advertising can include, among others, a mutual fund from Fidelity Investments. These and other advertisements can be included in the set of images to be displayed.

Although the above has been generally described in terms of a selected sequence of steps, other steps can be used. Other steps can be inserted into the present method. Steps described can also change in order, as well as further be combined, or even separated. The steps can be performed using software, hardware, or a combination of hardware and software. Additionally, the information provided to the method can also be changed. This information can be changed on-the-fly or in-situ depending upon the application.

### III. DETAILED EMBODIMENT

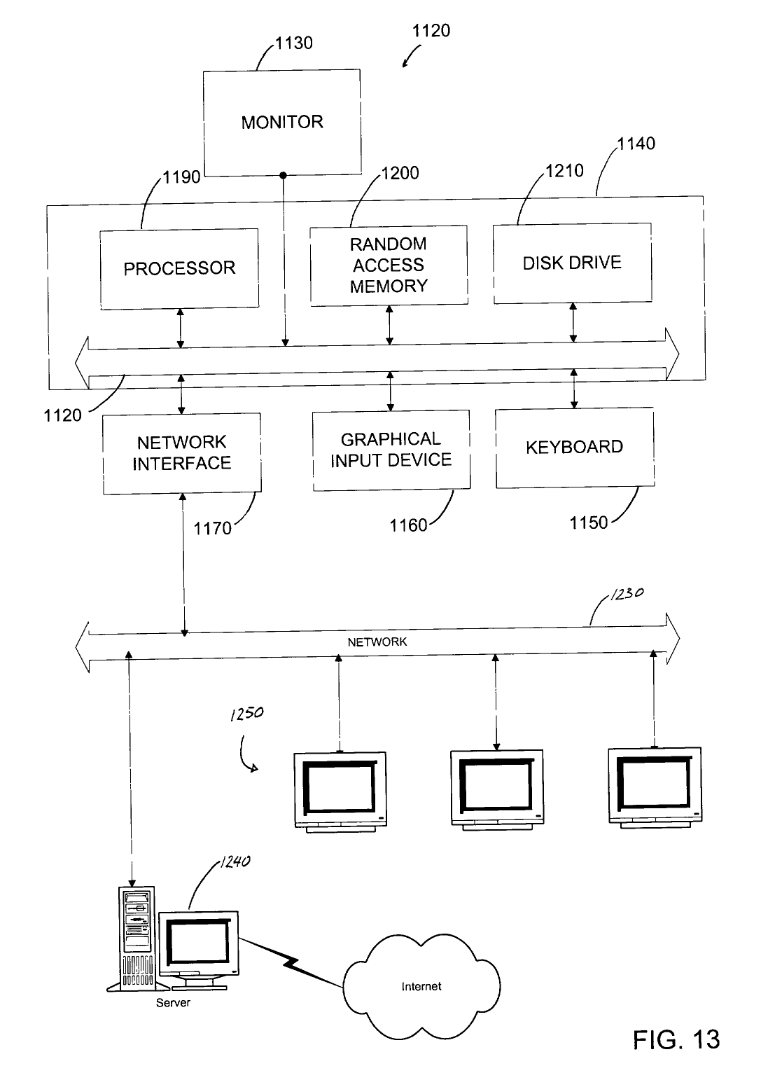

FIG. 13 is a more detailed block diagram of a image server 1120 according to a preferred embodiment of the present invention. Network image server (generally, a network server) 1120 includes a monitor 1130, a computer 1140, a keyboard 1150, a graphical input device (for example, a mouse) 1160, and a network interface card 1170. Computer 1140 includes familiar computer components such as a processor 1190, and memory storage devices, such as a random access memory (RAM) 1200, a disk drive 1210, and a system bus 1220 interconnecting the above components.

A mouse is but one example of a graphical input device 1160, also known as a pointing device, digitizing tablets, trackballs, and the like can also be used. RAM 1200 and disk drive 1210 are examples of tangible media for storage of computer programs, databases, images, data, audio sound, etc. for the display hardware, and the like. Other types of tangible media include floppy disks, removable hard disks, optical storage media such as CD-ROMS and bar codes, semiconductor memories such as flash memories, read-only-memories (ROMS), ASICs, and battery-backed volatile memories, and the like. Network interface card 1170 may be any conventional interface means to an internal network 1230 such as a modem, an Ethernet interface card, a dedicated line, and the like.

In one embodiment, an external network server 1240 is also coupled to internal network 1230. The external network server 1240 may be embodied similar to network server 1120.

In one embodiment, external network server 1240 and network server 1120 are embodied within one computer. However, in alternative embodiments of the present invention, the servers may be embodied as physically distinct computers.

In an embodiment, network server 1120 includes a 586 microprocessor-class based computer, running Microsoft Windows95™ operating system, and software developed by the present assignee. In another embodiment network server 1120 includes a G3 microprocessor running the OS/8 operating system from Apple Computer Corporation.

As illustrated in FIG. 13, any number of display sub-systems (hereinafter display systems) 1250 can be coupled to network server 1120 via any conventional network. In one embodiment, display systems 1250 comprise “thin” clients that such as Netscape Navigator, having appropriate plug-in application programs.

FIG. 13 is representative of but one type of system for embodying the present invention. It will be readily apparent to one of ordinary skill in the art that many system types and configurations are suitable for use in conjunction with the preferred embodiment of the present invention. Examples include Macintosh Computers from Apple Corporation, Sun Workstations from Sun Microsystems, and the like.

In one embodiment, the external network server 1240 provide images, text, audio, data, streaming data, and the like from an external network, such as the Internet, typically for storage into network server 1120, or for streaming data directly to display systems 1250. External network server 1240 may also provide demographic, sales data, audit data, and the like collected by network server 1120 for uploading to an off-site server.

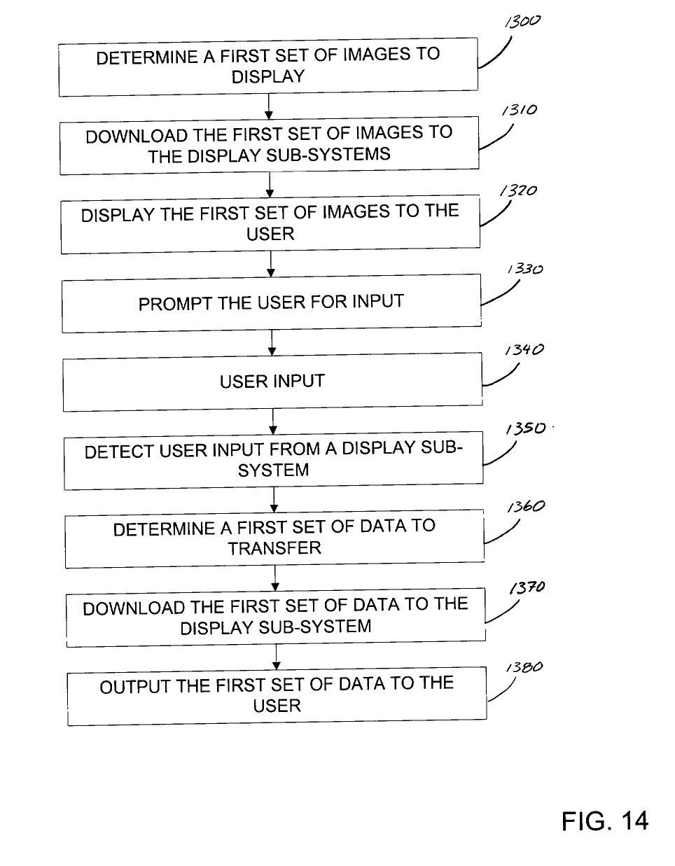

FIG. 14 illustrates a block diagram of a flow diagram according to an embodiment of the present invention. In particular, FIG. 14 illustrates a flow diagram of the operation of network server 1120. FIG. 14 includes references to the embodiment illustrated in FIG. 13 for sake of convenience.

Initially, a first set of images for display systems 1250 are determined, step 1300. As previously described in conjunction with FIGS. 9 and 10, a first set of images may be based upon the demographic data of shoppers or consumers, the geographic location of the store, and the like. Further, network server 1120 can determine the first set of images from a super-set of images stored therein for display, based upon the time of day. Once the first set of images has been determined, the first set of images is downloaded, typically by internal network 1230, to one or more display systems 1250, step 1310.

In one embodiment of the present invention, the images in display systems 1250 are individual still images (e.g. a slide show). In another embodiment, the images are part of a video presentation (e.g. a moving picture).

In embodiments of the present invention, audio information is also determined and downloaded to one or more of the display systems 1250. The audio information may or may not be associated with the first set of images. For example, in one case, the audio information may include background classical music, new age music, “Muzak” based music, and the like. In another example, the audio information may be associated with the first set of images, e.g. the sound-track to a moving picture or video.

In embodiments of the present invention, display systems 1250 displays the first set of images or a subset of the first set of images to the user, step 1320. The first set of images typically includes textual information that prompts the user to hit a button, or a series of buttons if the user is interested in what is displayed in the first set of images. step 1330. For example, the first set of images may be scenes from Hawaii, and may ask the user to hit a button if the user is interested in obtaining more information about Hawaiian vacations.

In an alternative embodiment, display systems 1250 include textual instructions such as “Push for More Info!” prompting the user to hit a button or keys on a keypad at anytime during the display of the first set of images. The additional information is returned in response to the user input. In such an embodiment, the first set of images need not include textual prompts.

In yet another embodiment, display systems 1250 may prompt the user to hit a button or other user input device, by way of an audio message.

If the user is interested in receiving further information associated with the first set of images, the user indicates so by the user input device, step 1340. As disclosed above, in embodiments of the present invention, the user input device may be a button, a keypad, a touch-screen, a microphone, and the like.

Network server 1120 then detects the user input from a display system 1250, step 1350. In one embodiment, each display system 1250 has a unique network address, such that network server 1120 can determine which display system 1250 the user is located. In another embodiment, each display system simply encodes identifying information along with the user input, to enable network server 1120 to identify the display system 1250 source of the user input.

In one embodiment of the present invention, the first set of images (and audio) are related to one particular product, service, information, and the like. For example, a Jet Ski Ad, a Public Service Announcement, and the like. When the first set of images has been played on display system 1250, a second set of images is determined by network server 1120, downloaded to display systems 1250, etc. As a result, when the user is prompted for user input, and the user provides user input, network server 1120 can easily determine what additional information the user is interested in. For example, the user is assumed to want information such as movie show times when the button is hit during the display of a movie trailer, and the like. Thus, in response to the user input, the network server 1120 can easily determine a first set of data, i.e., additional information, the user is interested in, step 1360.

In another embodiment of the present invention, the first set of images (and audio) are related to multiple products, services, and information, and the like. For example, the “Young Family” programming, as illustrated in FIG. 10. Thus, once the first set of images has been downloaded, the images cycle, until network server 1120 downloads another set of images for display. In such an embodiment, display systems 1250 keep track of which “item”: product, service, information source, and the like is being displayed on a display to the user when the user provides user input. Thus, the an indication of which “item” the user is interested in receiving further information, is transferred to the network server 1120.

In response to the user input, a second set of data is then downloaded to the appropriate display system 1250 generating the request, step 1370. The appropriate display system 1250 then outputs the second set of data to the user, step 1380.

In one embodiment of the present invention, the first set of data may include another set of images, a video, textual information and the like. Thus for example, if a first set of images displayed to a user is a slide show illustrating different views of an automobile, when the user hits a button during the slide show, a first set of data, for example, a video of the automobile in action, is retrieved, downloaded, and displayed on the appropriate display system 1250. A printout showing a map of how to get from the store to the closest dealership can also be printed out for the user.

In another embodiment of the present invention, the first set of data may be advertising or promotional in nature, and the like. For example, if a first set of images illustrates a product, when the user hits a button, a first set of data, can include addresses of places where the product can be bought, uses of the product, web-site addresses, and the like. The first set of data is then retrieved and downloaded to the appropriate display system 1250. The first set of data can be displayed to the user, and/or can be output in hardcopy form, for example utilizing print controller 409 in FIG. 4.

As another example, if the first set of images discloses factual information such as weather forecasts, financial indicators, television programming guides, maps, sport scores, breaking news, etc., the first set of data, textual information of information illustrated in the first set of images can be output in hardcopy from display system 1250.

In one embodiment of the present invention, the first set of data can be specific to particular users, enabling pinpoint marketing or tracking. In this embodiment, the user is prompted to enter a user identification number, or has a “store” card number read by display system 1250, for example. In such an embodiment a display system 1250 is typically equipped with a magnetic, a strip reader, or a keypad, and the like. The display system 1250 reads the user identification number and transmits the number to the network server 1120. In response to the user identification number, and known user demographic data, network server 1130 selects and transmits, a custom set of data to be displayed to the user.

For example, continuing the example above, if the first set of images is of Hawaii, based upon the user identification number, the first set of data retrieved by network server 1130 and displayed on a particular display system 1250 may be different based upon the demographic data. For example, for a more affluent user, the first set of data may describe golfing vacations available in Hawaii, whereas with an unmarried user, the first set of data may describe singles cruises available in Hawaii.

In the embodiment where streaming data sources, images, audio, and the like are used, the streaming data may be originated from network server 1120, or originated from the external network (e.g. the Internet). In such an embodiment the amount of image data, etc. stored within any particular display system 1250 is typically reduced.

### IV. CONCLUSION

Although the above has been generally described in terms of entertaining customers who wait in line in a retail store, the invention has a much broader range of applicability. As merely an example, the present invention can be applied to lines in a fast food place, a doctor's office, a hospital, a restaurant, government agency, or any other location where customers wait in line. Of course, the images and the data of a particular embodiment of the invention will depend highly upon the application.

While the above is a full description of the specific embodiments, various modifications, alternative constructions and equivalents may be used. Therefore, the above description and illustrations should not be taken as limiting the scope of the present invention which is defined by the appended claims.

What is claimed is:

1. A computer program product for a computer system including a processor for providing consumer information to a display system, the display system disposed adjacent to a point of sale register, the computer program product comprising:
a computer-readable memory comprising:
code that directs the processor to determine a first set of images to download to the display system;
code that directs the processor to transmit the first set of images to the display system;
code that directs the processor to detect user input from the display system in response to the first set of images being displayed on the display system;
code that directs the processor to determine a first set of data to transmit to the display system in response to the user input; and
code that directs the processor to transmit the first set of data to the display system.

2. The computer program product of claim 1
wherein the computer system is coupled to the display system through a network.

3. The computer program product of claim 2 wherein the computer-readable memory further comprises code that directs the processor to detect a user identification signal from the display system.

4. The computer program product of claim 3 wherein the code that directs the processor to determine the first set of data comprises code that directs the processor to determine a first set of data to transmit to the display system in response to the user input and to the user identification signal.

5. The computer program product of claim 3 wherein the computer-readable memory further comprises:
code that directs the processor to determine a second set of images in response to the user identification signal; and
code that directs the processor to transfer the second set of images to the display system in response to the user identification signal.

6. The computer program product of claim 2
wherein the first set of images and the first set of data are derived from data from the Internet.

7. The computer program product of claim 1 wherein the first set of images comprise news stories.

8. The computer program product of claim 1 wherein the first set of images are promotional.

9. The computer program product of claim 1 wherein the computerreadable memory further comprises:
code that directs the processor to determine audio sounds associated with the first set of images; and
code that directs the processor to transmit the audio sounds to the display system.

10. The computer program product of claim 1 wherein the first set of data comprises data from the class: logos, telephone numbers, addresses, current events, promotional.

11. A computer program product for a computer system including a processor for providing consumer information to a display system, the display system disposed prior to a cash register, the computer program product comprising:
code that directs the processor to determine a first set of images to download to the display system, the first set of images comprising a second set of images;
code that directs the processor to transmit the first set of images to the display system;
code that directs the processor to detect user input from the display system in response to the second set of images being displayed on the display system;
code that directs the processor to determine a third set of images to download to the display system in response to the user input; and
code that directs the processor to transmit the third set of images to the display system.

12. The computer program product of claim 11
wherein the computer system is coupled to a network server; and
wherein the computer-readable storage media further comprises code that directs the processor to receive the first set of images and the third set of images from the network server.

13. The computer program product of claim 11 wherein the computer-readable storage media further comprises:
code that directs the processor to determine a set of data to download to the display system in response to the user input; and
code that directs the processor to transmit the set of data to the display system.

14. The computer program product of claim 13
wherein the user input comprises a user identification indicator; and
wherein the code that directs the processor to determine the set of data comprises code that direct the processor to determine the set of data to download to the display system in response to the user identification signal.

15. The computer program product of claim 14 wherein the user input also comprises data from the class: points, security information, minutes, dollars.

16. The computer program product of claim 14 wherein the set of data includes data associated with the user identification indicator.

17. The computer program product of claim 16 wherein the data comprises a class comprising: points, dollars, credit.

18. The computer program product of claim 11
wherein the computer-readable storage media further comprises:
code that directs the processor to determine a first set of sound data to transmit to the display system.
code that directs the processor to transmit the first set of sound data to the display system;

19. A computer system for providing consumer information to a display system, the display system disposed adjacent to a point of sale region, the computer system comprising:
a processor;
a display coupled to the processor; and
a computer-readable memory comprising:
code that directs the processor to determine a first set of images to download to the display system;
code that directs the processor to transmit the first set of images to the display system;
code that directs the processor to detect user input from the display system in response to the first set of images being displayed on the display system;
code that directs the processor to determine a first set of data to transmit to the display system in response to the user input; and
code that directs the processor to transmit the first set of data to the display system.

20. The computer system of claim 19 further comprising a network server coupled to the processor for providing the first set of images and the first set of data.
